(19) United States
(12) Patent Application Publication
(10) Pub. No.: US 2013/0042091 A1
(43) Pub. Date: Feb. 14, 2013

(54) BIT Splitting Instruction

(71) Applicants: Mao Zeng, Austin, TX (US); Lucian Codrescu, Austin, TX (US); Erich James Plondke, Austin, TX (US)

(72) Inventors: Mao Zeng, Austin, TX (US); Lucian Codrescu, Austin, TX (US); Erich James Plondke, Austin, TX (US)

(73) Assignee: QUALCOMM INCORPORATED, San Diego, CA (US)

(21) Appl. No.: 13/208,401

(22) Filed: Aug. 12, 2011

(51) Int. Cl. G06F 9/30

(52) U.S. Cl. 712/220; 712/E09.016

(57) ABSTRACT

An instruction specifies a source value and an offset value. Upon execution of the instruction, a first result of the instruction and a second result of the instruction are generated. The first result is a first portion of the source value and the second result is a second portion of the source value.

### FIELD

The present disclosure is generally related to a bit splitting instruction.

### DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and internet protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player. Also, such wireless telephones can process executable instructions, including software applications, such as a web browser application, that can be used to access the Internet. As such, these wireless telephones can include significant computing capabilities.

Wireless telephones that perform multimedia processing such as audio or video decoding may often perform a bit unpacking operation. For example, the bit unpacking operation may extract specific bits from a coded bit stream during decoding of a compressed object. Current bit unpacking operations utilize at least two instructions to extract bits from a bit stream. The first instruction may pull or extract a group of bits from a source register and the second instruction may perform a shift operation on the remaining bits of the source register (e.g., to align the bits). Alternatively, a first instruction may store a first portion of bits from the source register into a first destination register and a second instruction may store a second portion of bits from the source register into a second destination register.

### SUMMARY

A single instruction that performs both bit extraction and alignment is disclosed. For example, the instruction may be used to perform bit splitting operations during audio or video decoding at an electronic device. In one implementation, the instruction may specify a source value (e.g., a bit stream) and an offset value. The source value may be data stored in a source register, such as data representing a compressed audio/video object. The offset value may be an immediate value (e.g., a numerical constant) or a register indicator (e.g., an offset register) storing the immediate value. For example, the register indicator may be “R1,” where register R1 stores the immediate value. When the instruction is executed, a first result (e.g., a first set of bits from the bit stream) and a second result (e.g., a second set of bits from the bit stream) may be generated. The first result and the second result may be stored in a first destination register and a second destination register, respectively. The first destination register and the second destination register may be registers of a destination register pair. Alternately, or in addition, the first destination register and the second destination register may be registers of a destination register file. For example, the first result may be extracted bits from a coded audio/video bit stream and the second result may be remaining bits of the coded audio/video bit stream. The remaining bits may be shifted to a least significant bit of a register (e.g., in preparation for a subsequent bit unpacking operation).

In a particular embodiment, an apparatus includes a memory storing an instruction that specifies a source value and an offset value. Upon execution, the instruction generates a first result of the instruction and a second result of the instruction. The first result is a first portion of the source value and the second result is a second portion of the source value. For example, if the source value is 32 bits and the offset value is eight (8), the first portion may be the 8 least significant bits of the source value and the second portion may be the remaining 24 bits of the source value.

In another particular embodiment, a method includes receiving a single instruction that indicates a source value and an offset value. The method includes executing the single instruction to generate a first result and a second result of the instruction. The method further includes storing the first result in a first destination register and storing the second result in a second destination register. The first result is a first portion of the source value and the second result is a second portion of the source value.

In another particular embodiment, an apparatus includes means for storing an instruction that specifies a source value and an offset value. The apparatus further includes means for executing the instruction to generate a first result of the instruction and a second result of the instruction. The first result is a first portion of the source value and the second result is a second portion of the source value.

In another particular embodiment, a non-transitory computer-readable medium includes program code that, when executed by a processor, causes the processor to receive a single instruction that indicates a source value and an offset value, to execute the single instruction to generate a first result of the instruction and a second result of the instruction, and to store the first result in a first destination register and store the second result in a second destination register. The first result is a first portion of the source value and the second result is a second portion of the source value.

One particular advantage provided by at least one of the disclosed embodiments is reduced code size and fewer execution cycles for applications (e.g., embedded multimedia processing applications) due to use of a single instruction (instead of multiple instructions) to perform bit extraction (e.g., to unpack words of varying lengths from a continuous bit stream).

Other aspects, advantages, and features of the present disclosure will become apparent after review of the entire application, including the following sections: Brief Description of the Drawings, Detailed Description, and the Claims.

### BRIEF DESCRIPTION OF THE DRAWINGS

FIG. 1 is a diagram that illustrates executing an instruction that specifies a source value and an offset value;

FIG. 2 is a diagram that illustrates executing an instruction that specifies a source value and an offset value;

FIG. 3 is a diagram of a particular illustrative embodiment of a system that includes a memory storing an instruction that specifies a source value and an offset value;

FIG. 4 is a flow chart of a particular illustrative embodiment of a method of executing an instruction that specifies a source value and an offset value; and

FIG. 5 is a block diagram of a wireless device including a processor operable to execute an instruction that specifies a source value and an offset value.

### DETAILED DESCRIPTION

An instruction for performing bit extraction may include a source value (e.g., a bit stream) and an offset value (e.g., an immediate value or a register indicator of an offset register storing the immediate value). The instruction may optionally identify destination registers. When the instruction is executed, a first result and a second result may be generated. The first result may be a first set of bits from the bit stream and the second result may be a second set of bits from the bit stream. The second result may include bits from the source value that are not included in the first result. The first result may be stored in a first destination register and the second result may be stored in a second destination register. The first result and the second result may both be shifted to the least significant bit positions in their respective destination registers. When a single instruction is invoked for performing bit extraction, fewer processor execution cycles and a reduction in code size may be achieved.

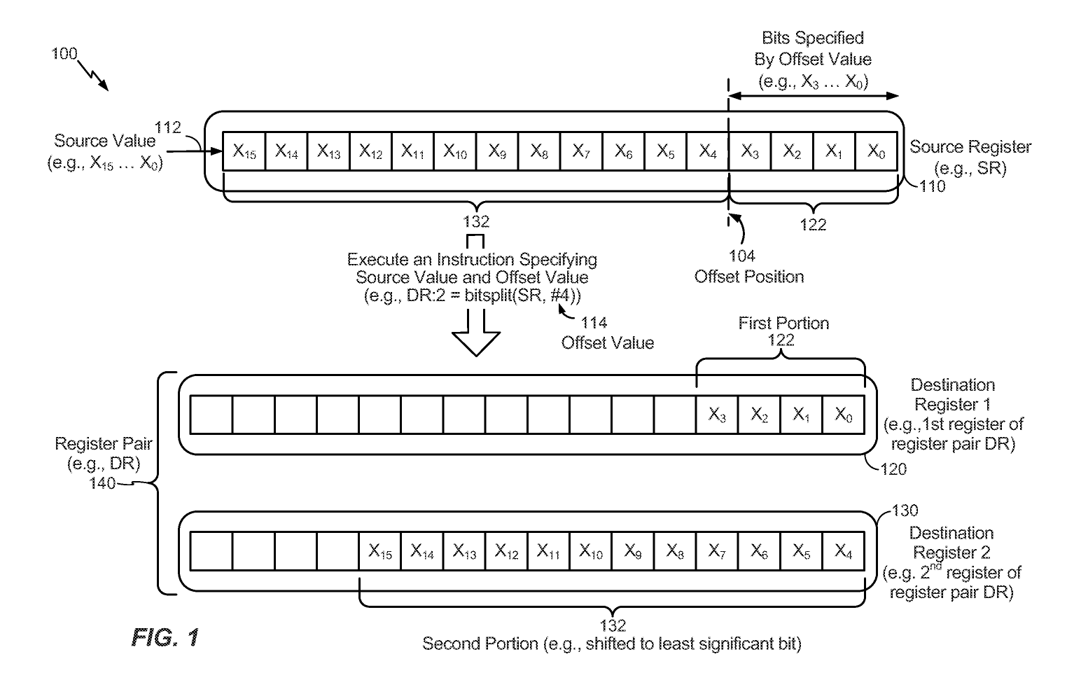

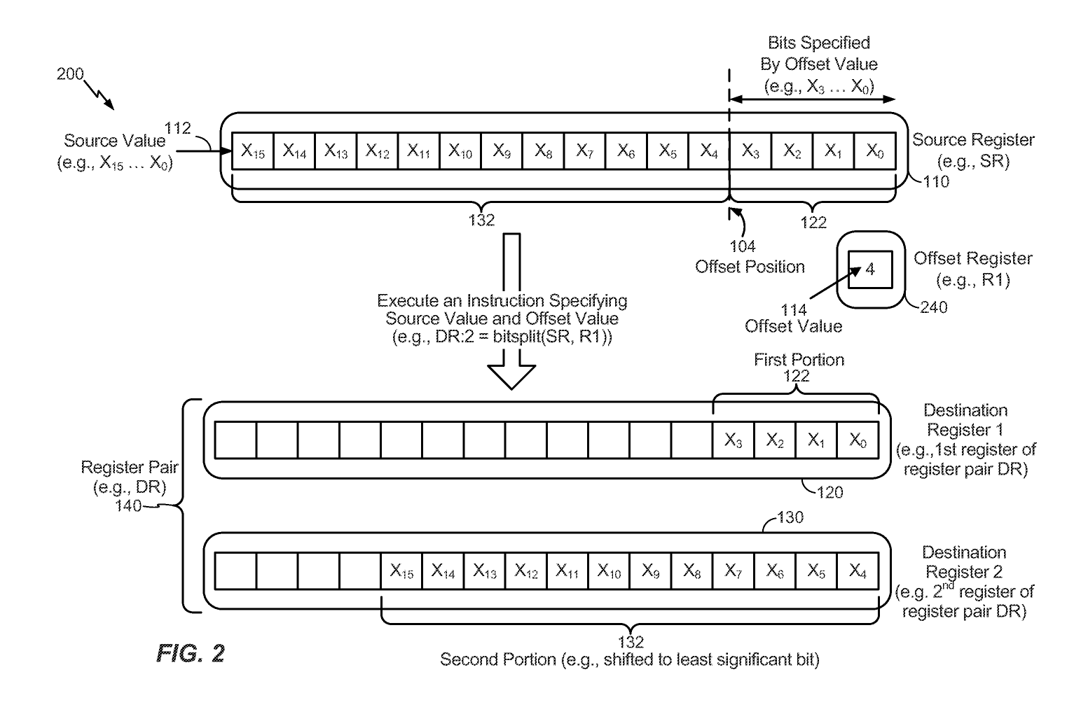

FIGS. 1-2 depict two examples of execution of a bit splitting instruction specifying a source value and an offset value. Referring to FIG. 1, a first illustrative example of execution of the bit splitting instruction is disclosed and generally designated 100.

In a particular embodiment, a bit splitting instruction may specify a source value and an offset value. Alternately, the bit splitting instruction may specify an offset value, a source register, and destination registers. The source register may include the source value. For example, as illustrated in FIG. 1, the bit splitting instruction may be “DR:2=bitsplit (SR, #4),” where SR is a source register 110 including a source value 112 (e.g., X₁₅ . . . X₀), ‘#4’ is an offset value 114, and DR is a destination register pair 140 including a first destination register 120 and a second destination register 130. The source value 112 may represent a portion of a coded audio/video bit stream. Alternately, the source value 112 may be another type of data. The source value 112 may include bits to be extracted from the coded bit stream during a decoding operation. For example, the decoding operation may be decoding of compressed multimedia objects (e.g., one or more compressed audio objects, one or more compressed video objects, or any combination thereof), and the instruction may be executable to perform bit unpacking operations (e.g., to unpack/extract words of varying lengths from a continuous bit stream). The multimedia objects may be compressed using Huffman coding or another coding algorithm. The offset value 114 may specify a number of bits to be extracted from the bit stream. Alternately, the offset value may specify a position in the bit stream to perform a split (i.e., a location to break up or divide the bit stream). As illustrated, the offset value 114 may specify an offset position 104 in the source register 110 at which to perform a split. For example, in FIG. 1, the offset position 104 indicates that bits X₃ . . . X₀ are to be split from the remainder of the source value 112. The offset value 114 may thus define a first portion 122 (e.g., bits X₃ . . . X₀) of the source register 110 and a second portion 132 (e.g., bits X₁₅ . . . X₄) of the source register 110. In another embodiment, the source value 112 may be directly represented as an immediate value in the bit splitting instruction and the offset value 114 may specify a position in the source value 112 at which to perform the split. The offset value 114 may thus define the first portion 122 of the source value 112 and the second portion 132 of the source value 112.

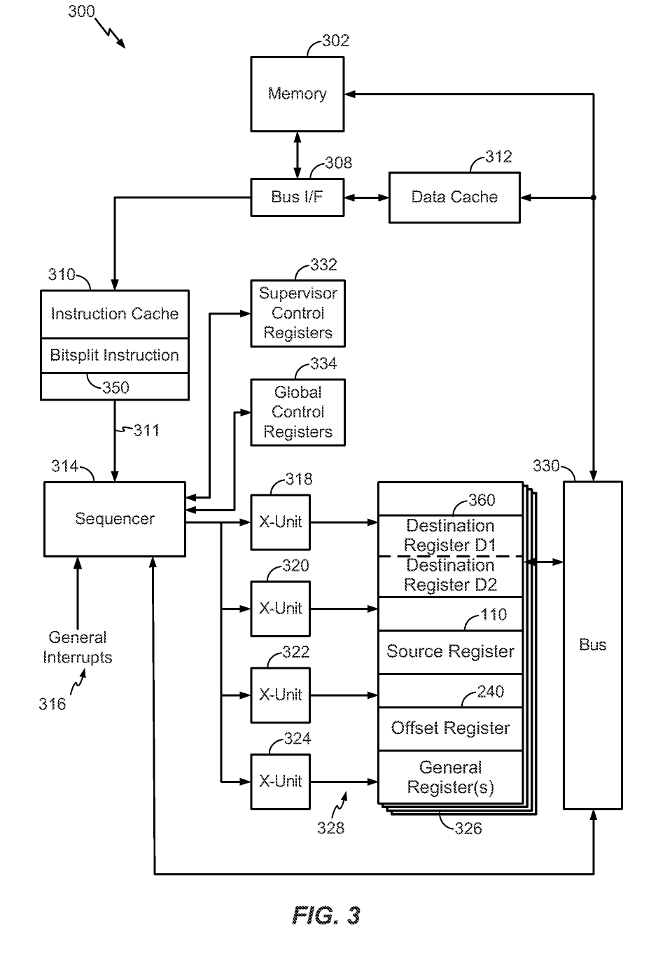

During operation, the bit splitting instruction specifying the source value 112 (or the source register 110 including the source value 112) and the offset value 114 may be stored in a memory (e.g., as illustrated in FIG. 3) and may be executed by an execution unit of a processor. When executed, the bit splitting instruction generates a first result and a second result. In a particular embodiment, the first result may be the first portion 122 of the source register 110 and the second result may be the second portion 132 of the source register 110. The second portion 132 may include at least one bit of the source register 110 that is not in the first portion 122.

To illustrate, the offset value 114 (e.g., ‘4’) may indicate that the first portion 122 of the source register 110 includes bits “X₃ X₂ X₁ X₀.” (i.e., the 4 least significant bits of the source register 110). The second portion 132 may be the remaining bits of the source register 110 that are not in the first portion 122 (i.e., bits “X₁₅ . . . X₄”). The first portion 122 may be stored in the first destination register 120 of the destination register pair 140, and the second portion 132 may be stored in the second destination register 130 of the destination register pair 140. Further, the first portion 122 may be shifted to the least significant bit position of the first destination register 120 and the second portion 132 may be shifted to the least significant bit position of the second destination register 130. Thus, during decoding of a compressed object, specific bits of a coded bit stream may be extracted and aligned in multiple destinations using a single instruction.

Referring to FIG. 2, a second illustrative example of executing a bit splitting instruction is disclosed and generally designated 200. For example, the bit splitting instruction may be “DR:2=bitsplit(SR, R1),” where SR is the source register 110 including the source value 112 (e.g., X₁₅ . . . X₀), “R1” is an offset register 240 storing the offset value 114 (e.g., ‘4’), and DR is the destination register pair 140 including the first destination register 120 and the second destination register 130.

During operation, the bit splitting instruction specifying the source value 112 and the offset register 240 may be stored in a memory (e.g., as illustrated in FIG. 3), and may be executed by an execution unit of a processor. The offset value 114 may be an immediate value (e.g., ‘4’) stored in the offset register 240 (e.g., register R1), as illustrated in FIG. 2. The source value 112 may represent a portion of a coded audio/video bit stream. Alternately, the source value 112 may represent another type of data. The source value 112 may include bits to be extracted from a coded bit stream during a decoding operation. For example, the decoding operation may be decoding of compressed multimedia objects. The offset value 114 stored in the offset register 240 may specify a number of bits to be extracted from the bit stream. Alternately, the offset value may specify a position in the bit stream at which to perform a split (i.e., a location to break up or divide the bit stream into two parts, where each part is decoded separately). For example, the offset value 114 stored in the offset register 240 may specify an offset position 104 in the source register 110 at which to perform a split.

When executed, the bit splitting instruction generates a first result and a second result. The first result may be the first portion 122 of the source register 110 and the second result may be the second portion 132 of the source register 110. In a particular embodiment, the source value 112 may be a concatenation of the first result and the second result (i.e., the first portion 122 and the second portion 132). The first portion 122 and the second portion 132 may be stored in a first register and a second register of a register pair. To illustrate, the offset value 114 (e.g., ‘4’) stored in the offset register 240 (e.g., register R1) may indicate that the first portion 122 of the source register 110 includes bits “X₃ X₂ X₁ X₀.” (i.e., the 4 least significant bits of the source register 110). The second portion 132 may be the remaining bits of the source register 110 that are not in the first portion 122 (i.e., bits “X₁₅ . . . X₄”). The first portion 122 may be stored in the first destination register 120 of the destination register pair 140, and the second portion 132 may be stored in the second destination register 130 of the destination register pair 140. Further, the first portion 122 may be shifted to the least significant bit position of the first destination register 120 and the second portion 132 may be shifted to the least significant bit position of the second destination register 130.

Referring to FIG. 3, a particular illustrative embodiment of a system operable to store and process a bit splitting instruction 350 is disclosed and generally designated 300. The system 300 may include a memory 302 coupled to an instruction cache 310 via a bus interface 308. In a particular embodiment, all or a portion of the system 300 may be integrated into a processor.

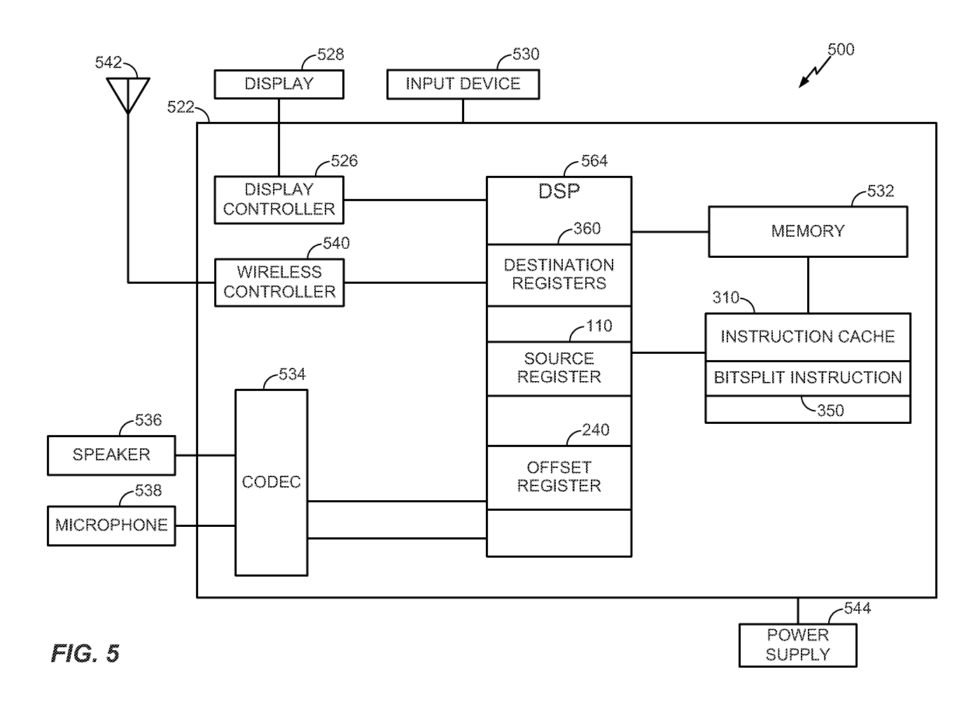

The bit splitting instruction 350 may specify a source value (e.g., data stored in source register 110) and an offset value, as illustrated in FIGS. 1-2. The offset value may be an immediate value (e.g., a numerical constant), as illustrated in FIG. 1 or the offset value may be a register indicator of a register (e.g., the offset register 240) storing the immediate value, as illustrated in FIG. 2. Alternately or in addition, the bit splitting instruction 350 may specify destination registers (e.g., a destination register pair 360). If no destination register is specified by the bit splitting instruction 350, the results of the bit splitting instruction 350 may be stored in a temporary register or a default register of the system 300. The memory 302 may transmit the bit splitting instruction 350 to the instruction cache 310 via the bus interface 308. A data cache 312 may also be coupled to the memory 302 via the bus interface 308. In a particular embodiment, the memory 302 may be accessible by a decoder (e.g., the CODEC of FIG. 5) that uses the bit splitting instruction to perform bit extraction, bit unpacking, bit splitting, or any combination thereof.

The instruction cache 310 may be coupled to a sequencer 314 via a bus 311. The sequencer 314 may receive general interrupts 316, which may be retrieved from an interrupt register (not shown). In a particular embodiment, the instruction cache 310 may be coupled to the sequencer 314 via a plurality of current instruction registers (not shown), which may be coupled to the bus 311 and associated with particular threads (e.g., hardware threads) of the processor 300. In a particular embodiment, the processor 300 may be an interleaved multi-threaded processor including six (6) threads.

In a particular embodiment, the bus 314 may be a one-hundred and twenty-eight bit (128-bit) bus and the sequencer 314 may be configured to retrieve instructions from the memory 302 via instruction packets (e.g., a very long instruction word (VLIW) instruction packet including one or more bit splitting instructions 350) having a length of thirty-two (32) bits each. The bus 311 may be coupled to a first instruction execution unit 318, a second instruction execution unit 320, a third instruction execution unit 322, and a fourth instruction execution unit 324. It should be noted that there may be fewer or more instruction execution units. Each instruction execution unit 318-324 may be coupled to a general register file 326 via a first bus 328. The general register file 326 may also be coupled to the sequencer 314, the data cache 312, and the memory 302 via a second bus 330. The general register file 326 may include the destination registers 360 (e.g., the destination register pair 140 of FIGS. 1-2), the source register 110, and the offset register 240. The destination registers 360 may include the first destination register 120 and the second destination register 130 of FIGS. 1-2.

The system 300 may also include supervisor control registers 332 and global control registers 334 to store bits that may be accessed by control logic within the sequencer 314 to determine whether to accept interrupts (e.g., the general interrupts 316) and to control execution of instructions.

In a particular embodiment, any of the execution units 318-324 may execute the bit splitting instruction 350 to generate a first result and a second result. In another embodiment, some, but not all, of the execution units 318-324 may execute the bit splitting instruction 350. The first result may be a first portion of the source value stored in the source register 110 and the second result may be a second portion of the source value stored in the source register 110. The first portion may be stored in a first of the destination registers 360 and the second portion may be stored in a second of the destination registers 360. Further, the first portion and the second portion may be shifted to the least significant bits of their respective destination registers. Thus, during decoding of compressed objects, specific bits of a coded bit stream may be extracted from a source register and aligned in destination registers using a single instruction. The data in a first destination register may subsequently be decoded. The data in a second destination register may be subjected to another bit splitting operation after data in the first destination register is decoded (or during decoding). The bit splitting instruction 350 may achieve an overall reduction in code size and perform fewer execution cycles of a processor due to the use of a single instruction to perform bit extraction.

It should be noted that the system 300 depicted in FIG. 3 is for example only. The disclosed instruction and techniques may be supported by and executed within other architectures (e.g., micro-architectures and digital signal processor (DSP) architectures). For example, an alternate DSP architecture may include more, fewer, and/or different components than the system 300 of FIG. 3. To illustrate, an alternate DSP architecture may include two execution units and two load/store units instead of four execution units, as illustrated in FIG. 3.

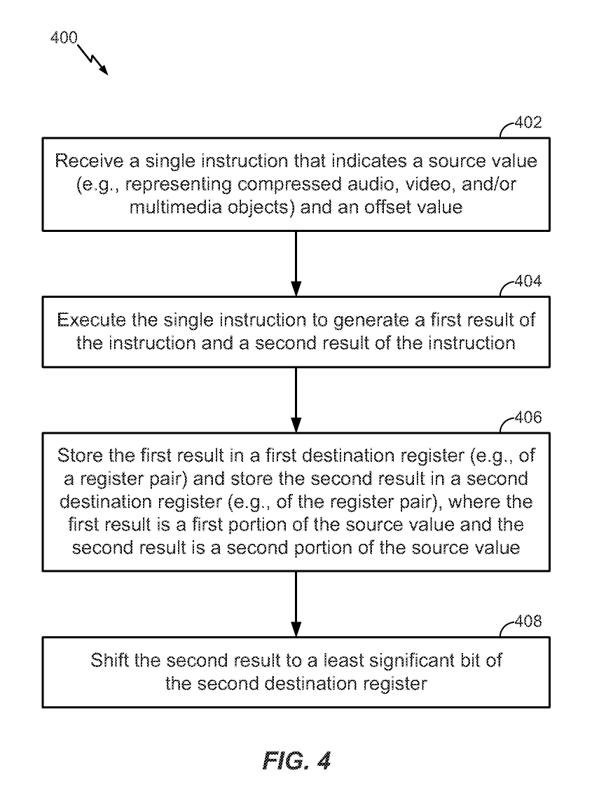

Referring to FIG. 4, a flow chart of a particular illustrative embodiment of a method of processing an instruction that specifies a source value and an offset value is depicted and generally designated 400. In an illustrative embodiment, the method 400 may be performed at the system 300 of FIG. 3 and is illustrated with reference to FIGS. 1-2.

The method 400 may include receiving an instruction that indicates a source value and an offset value, at 402. For example, in FIG. 3, the bit splitting instruction 350 may be received at one of the execution units 318-324. In a particular embodiment, the source value may represent a compressed audio, video, and/or multimedia object. The method 400 may also include executing the instruction to generate a first result of the instruction and a second result of the instruction, at 404. For example, in FIG. 3, the bit splitting instruction 350 may be executed by one of the execution units 318-324 to generate a first result and a second result. In a particular embodiment, executing the instruction may include retrieving the offset value from an offset register (e.g., the offset register 240 of FIG. 2).

The method 400 may further include storing the first result in a first destination register and storing the second result in a second destination register, at 406. In a particular embodiment, the first destination register and the second destination register may be part of a destination register pair (e.g., the destination register pair 140 of FIGS. 1-2). In a particular embodiment, the destination register pair may be part of a register file. In an illustrative embodiment, the first result may be a first portion of the source value and the second result may be a second portion of the source value. The second portion may include at least one bit of the source value that is not in the first portion. To illustrate, in FIG. 1, the second portion 132 (X₁₅ . . . X₄) includes bits not in the first portion 122 (X₃ . . . X₀). The source value may be a concatenation of the first portion and the second portion. To illustrate, in FIGS. 1-2, the source value 112 (X₁₅ . . . X₀) is a concatenation of the first portion 122 (X₃ . . . X₀) and the second portion 132 (X₁₅ . . . X₄).

The method 400 may also include shifting the second result to a least significant bit of the second destination register, at 408. For example, in FIGS. 1-2, the second portion 132 may be shifted to the least significant bit of the second destination register 130, as illustrated. A processor or component thereof may be configured such that the offset value in a bit splitting instruction is relative to the least significant bit (e.g., rightmost bit) of a source register. Shifting the second portion to the least significant bit of the second destination register may prepare the second portion for a subsequent bit splitting instruction.

The method 400 of FIG. 4 may be implemented by a field-programmable gate array (FPGA) device, an application-specific integrated circuit (ASIC), a processing unit such as a central processing unit (CPU), a digital signal processor (DSP), a controller, another hardware device, firmware, or any combination thereof. As an example, the method 400 of FIG. 4 can be performed by a processor or component thereof that executes program code or instructions, as described with respect to FIGS. 3 and 5.

Referring to FIG. 5, a block diagram of a particular illustrative embodiment of a wireless device that includes a memory 532 storing a bit splitting instruction 350 specifying a source value and an offset value is depicted and generally designated 500. The device 500 includes a processor, such as a digital signal processor (DSP) 564, coupled to the memory 532. An instruction cache (e.g., illustrative instruction cache 310) may also be coupled to the memory 532 and to the DSP 564. In a particular embodiment, the memory 532 stores and transmits instructions executable by the DSP 564, such as the bit splitting instruction 350, to the instruction cache 310.

FIG. 5 also shows a display controller 526 that is coupled to the DSP 564 and to a display 528. A coder/decoder (CODEC) 534 can also be coupled to the DSP 564. A speaker 536 and a microphone 538 can be coupled to the CODEC 534. FIG. 5 also indicates that a wireless controller 540 can be coupled to the DSP 564 and to a wireless antenna 542. In a particular embodiment, the DSP 564, the display controller 526, the memory 532, the CODEC 534, and the wireless controller 540 are included in a system-in-package or system-on-chip device 522. In a particular embodiment, the memory 532 or the instruction cache 310 including the bit splitting instruction 350 may be accessible by the CODEC 534 that uses the bit splitting instruction 350 to perform bit extraction, bit unpacking, bit splitting, or any combination thereof, during audio or video decoding at an electronic device (e.g., the wireless device 500).

When processed, the bit splitting instruction 350 generates a first result of the bit splitting instruction 350 and a second result of the bit splitting instruction 350. Upon generating the first and second results, the DSP 564 or a component thereof may store the first result in a first destination register and store the second result in a second destination register. The first destination register (D1 in FIG. 3) and the second destination register (D2 in FIG. 3) may be part of the destination register pair 360 of register file 326. The source value specified by the bit splitting instruction 350 may be stored in a source register 110 of the DSP 564. Further, the offset value specified by the bit splitting instruction 350 may be stored in an offset register 240 of the DSP 564.

In a particular embodiment, an input device 530 and a power supply 544 are coupled to the system-on-chip device 522. Moreover, in a particular embodiment, as illustrated in FIG. 5, the display 528, the input device 530, the speaker 536, the microphone 538, the wireless antenna 542, and the power supply 544 are external to the system-on-chip device 522. However, each of the display 528, the input device 530, the speaker 536, the microphone 538, the wireless antenna 542, and the power supply 544 can be coupled to a component of the system-on-chip device 522, such as an interface or a controller.

It should be noted that although FIG. 5 depicts a wireless communications device, a processor for executing a bit splitting instruction, such as the DSP 564, the memory 532, and the instruction cache 310 storing the bit splitting instruction may alternately be integrated into a set-top box, a music player, a video player, an entertainment unit, a navigation device, a personal digital assistant (PDA), a fixed location data unit, or a computer.

In conjunction with the described embodiments, an apparatus is disclosed that includes means for storing an instruction that specifies a source value and an offset value. For example, the means for storing may be the memory 302 of FIG. 3, the memory 532 of FIG. 5, the instruction cache 310 of FIG. 3 and FIG. 5, one or more other devices configured to store an instruction, or any combination thereof

The apparatus may also include means for executing the instruction to generate a first result of the instruction and a second result of the instruction, where the first result is a first portion of the source value and the second result is a second portion of the source value. For example the means for executing may include one or more of the execution units 318, 320, 322, and 324 of FIG. 3, the DSP 564 of FIG. 5, one or more other devices configured to execute an instruction, or any combination thereof.

The apparatus may further include means for storing the first result of the instruction. For example, the means for storing the first result may include the first destination register 120 of the register pair 140 of FIGS. 1-2, the destination registers 360 of FIG. 3, the general registers 326 of FIG. 3, the destination registers 360 of FIG. 5, one or more other devices configured to store a first result, or any combination thereof.

The apparatus may also include means for storing the second result of the instruction. For example, the means for storing the second result may include the second destination register 130 of the register pair 140 of FIGS. 1-2, the destination registers 360 of FIG. 3, the general registers 326 of FIG. 3, the destination registers 360 of FIG. 5, one or more other devices configured to store the second result, or any combination thereof.

The apparatus may further include means for shifting the second portion to a least significant bit of the means for storing the second result. For example, the means for shifting may be the execution units 314-324 of FIG. 3, one or more other devices configured to shift data, or any combination thereof.

Those of skill would further appreciate that the various illustrative logical blocks, configurations, modules, circuits, and algorithm steps described in connection with the embodiments disclosed herein may be implemented as electronic hardware, computer software, or combinations of both. Various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary non-transitory (e.g. tangible) storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal In the alternative, the processor and the storage medium may reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. An apparatus comprising:
memory storing an instruction that specifies a source value and an offset value and that upon execution generates a first result of the instruction and a second result of the instruction, wherein the first result is a first portion of the source value and the second result is a second portion of the source value.

2. The apparatus of claim 1, wherein the first portion is defined by the offset value.

3. The apparatus of claim 2, wherein the offset value is an immediate value or a register indicator of a register storing the immediate value and wherein the immediate value is an integer.

4. The apparatus of claim 2, wherein the source value is stored in a source register.

5. The apparatus of claim 1, wherein the second portion includes at least one bit of the source value that is not in the first portion.

6. The apparatus of claim 1, wherein the second result is stored in a register and wherein the second portion is shifted to a least significant bit of the register.

7. The apparatus of claim 1, wherein the source value includes data representing a compressed audio object, a compressed video object, or any combination thereof.

8. The apparatus of claim 1, wherein the memory is accessible by a decoder that is operable to perform a bit extraction operation, a bit unpacking operation, a bit splitting operation, or any combination thereof.

9. The apparatus of claim 1, wherein the first result and the second result are stored in registers of a destination register pair.

10. The apparatus of claim 1, wherein the source value is a concatenation of the first result and the second result.

11. The apparatus of claim 1, wherein the instruction further specifies a source register and destination registers and wherein the first portion is stored in a first of the destination registers and the second portion is stored in a second of the destination registers.

12. The apparatus of claim 11, wherein each bit of the source register is included in at least one of the first portion and the second portion.

13. The apparatus of claim 11, wherein the destination registers are part of a register file.

14. The apparatus of claim 1, further comprising a device selected from the group consisting of a set top box, a music player, a video player, an entertainment unit, a navigation device, a communications device, a personal digital assistant (PDA), a fixed location data unit, and a computer, into which the memory is integrated.

15. A method comprising:
receiving a single instruction that indicates a source value and an offset value;
executing the single instruction to generate a first result of the instruction and a second result of the instruction; and
storing the first result in a first destination register and storing the second result in a second destination register, wherein the first result is a first portion of the source value and the second result is a second portion of the source value.

16. The method of claim 15, further comprising shifting the second result to a least significant bit of the second destination register.

17. The method of claim 15, further comprising retrieving the offset value from an offset register.

18. An apparatus comprising:
means for storing an instruction that specifies a source value and an offset value; and
means for executing the instruction to generate a first result of the instruction and a second result of the instruction, wherein the first result is a first portion of the source value and the second result is a second portion of the source value.

19. The apparatus of claim 18, further comprising:
means for storing the first result of the instruction; and
means for storing a second result of the instruction.

20. The apparatus of claim 19, further comprising means for shifting the second portion to a least significant bit of the means for storing the second result.

21. A non-transitory computer-readable medium including program code that, when executed by a processor, causes the processor to:
receive a single instruction that indicates a source value and an offset value;
execute the single instruction to generate a first result of the instruction and a second result of the instruction; and
store the first result in a first destination register and store the second result in a second destination register, wherein the first result is a first portion of the source value and the second result is a second portion of the source value.

22. The non-transitory computer-readable medium of claim 21, further including program code that, when executed by the processor, causes the processor to shift the second result to a least significant bit of the second destination register.
